(19) United States
(12) Patent Application Publication
(10) Pub. No.: US 2011/0044571 A1
(43) Pub. Date: Feb. 24, 2011

(54) Method for Producing Vehicle Wheel Hubs and Wheel Hubs Made Using This Method

(76) Inventor: Marcus Caldana, Lidkoping (SE)

Correspondence Address: STITES & HARBISON PLLC, 1199 NORTH FAIRFAX STREET, SUITE 900, ALEXANDRIA, VA, 22314, US

(21) Appl. No.: 12/922,512

(22) PCT Filed: Mar. 16, 2009
(86) PCT No.: PCT/EP09/53097

§ 371 Date: Nov. 12, 2010

(30) Foreign Application Priority Data
Mar. 17, 2008 (IT) BO2008A000171

(51) Int. Cl. F16C 13/00

(52) U.S. Cl. 384/544

(57) ABSTRACT

In order to simplify mounting of the inner ring (5) of one of the bearings (102) of a wheel hub on the associated spindle (1) and in order to perform keying together of this ring and the spindle by means of multiple-lobe—for example three-lobe-machining which can be performed using the same machine for turning the spindle and the ring, this same three-lobe machining operation is such as to involve all or only partly the shoulder (6) of the spindle and involve, in recessed form, the corresponding inner end of the ring (5) intended to rest against this shoulder, so that the said ring (5) may be mounted on the spindle (1) as though these two parts were two normal parts with a round cross-section and therefore without any need for prior relative angular alignment thereof. After these two parts have been engaged together axially, a relative rotation of said parts is performed so as to engage correctly the three-lobe profile (100) of the ring (5) with the corresponding three-lobe profile (10) of the shoulder (6) of the spindle and vice versa and, after this step, the edge (201′) for axially locking the said inner ring (5) of the bearing is formed by means of rolling.

The invention relates to vehicle wheel hubs, namely to those case-like structures with bearings which support the wheel and the brake disc and which are designed to be constrained in a fixed or articulated manner to the rear axle unit or the front axle unit of a motor vehicle.

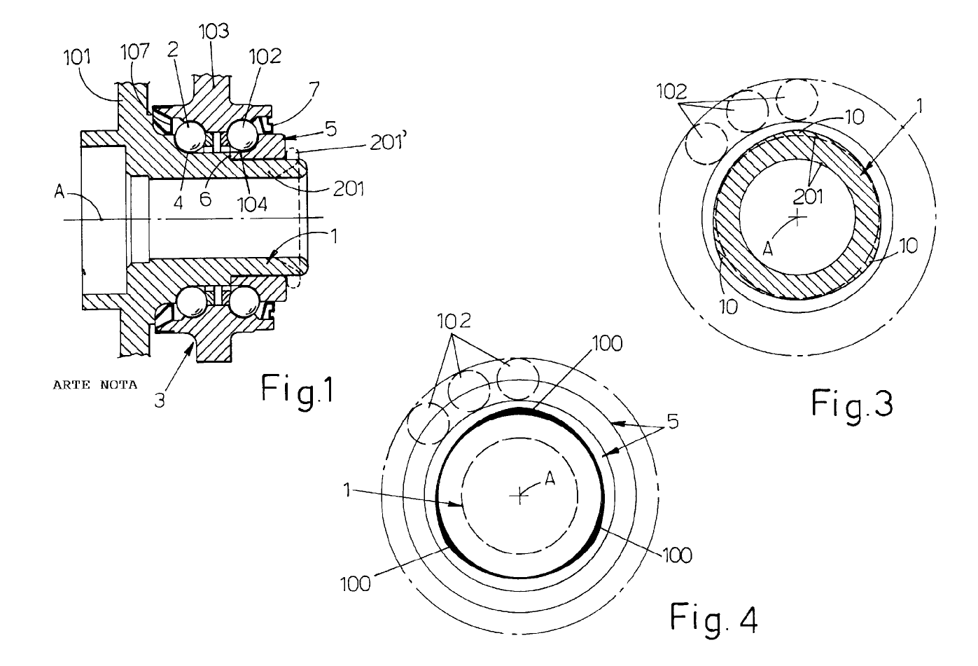

In particular, the invention relates to the wheel hubs of the type shown in FIG. 1 of the accompanying set of drawings, provided with a spindle 1 which supports integrally at one end a perpendicular flange 101 and which, via two interposed crown parts 2, 102 of revolving bodies consisting, for example, of spheres or other equivalent means such as, for example, cylindrical or conical needle rollers, cooperates with the possibility of a relative rotational movement, about the common axis A, with an outer crown part 3 usually provided with support lugs 103 connected for example to the front axle unit or rear axle unit of the motor vehicle, while the said flange 101 is designed in any suitable way to support the brake disc and rim of the wheel. The scope of the invention also includes wheel hubs similar or equivalent to that shown in FIG. 1 and used also in a different manner, for example for connection by means of the spindle 1 to the supporting parts and for connection to the wheel and to the brake disc by means of the bush 3.

In the wheel hub in question the crown part of the rolling means 2 travels along an annular track 4 formed directly on the outer side surface of the spindle 1, while the other crown part of rolling means 102 travels along an annular track 104 formed on a ring 5 which is mounted on an externally tapered portion 201 of the spindle 1 and is firmly fixed onto the latter by means of abutment against an inner shoulder 6 and against an outer edge 201′ formed, during a step following said mounting operation, by means of rolling of the section, projecting from the ring 5, of the said support portion 201 of the spindle.

The space inside which the crown parts of the rolling means 2, 102 operate is filled with lubricant and is closed by known sealing means 7, 107.

Practical experience has shown that the force exerted by the annular rolled edge 201′ on the inner ring 5 of the bearing is more than sufficient to lock axially this ring on the associated support part, but instead is not able to prevent any accidental relative rotation of the ring 5 and spindle 1, in particular when considerable friction is present between this ring and the associated crown part of rolling means 102. This condition may cause vibrations and noise, may reduce the average working life of the bearing and, if neglected, may result in overheating and breakage of the tapered support portion 201, 201′ of the spindle 1 which may freely disengage from the casing 3, with the consequences which may be imagined.

In order to overcome this serious drawback, the known art teaches that it is possible to mount the ring 5 on the spindle 1 using keying means arranged in between and consisting for example of splined male and female profiles which are formed longitudinally on the outer surface of the spindle and on the inner surface of the ring 5 and which may thus be engaged without any possibility of relative rotation and the axial movements of which are also prevented by means of rolling of the edge 201′. This solution is, for example, illustrated in the US patent application 2002/0025093 published on 28 Feb. 2002 entitled “Bearing device for drive wheel”.

This same solution, however, has the drawback of a high production cost in that the formation of the said keying grooves requires specific machining techniques with setting of the workpieces on machine tools different from turning machine tools.

Still with the aim of overcoming the serious drawback mentioned above, also known is the solution (described in the U.S. Pat. No. 7,241,054) which can be produced on an industrial scale at a very low cost, during the same operation of turning the workpieces and which envisages the formation, on the side surface for engagement between ring 5 and spindle 1, of sections with a radially multiple-lobe form, for example a three-lobe form.

Although, this solution, on the on hand, offers the advantage compared to the previous solution of being able to be produced with very low costs, on the other hand it results in difficulties during engagement between the parts 5 and 1, owing to the need to correctly align these same parts relative to each other, both in the axial direction and in the angular direction, even before they are axially engaged together.

The object of the invention is to solve this technical problem of engagement, in particular to simplify this engagement operation and simplify the formation of the keying means, with a method as described in claim 1 and in the subsequent dependent claims, based on the following proposed solution: the machining operation for the three-lobe engaged arrangement is performed so as to involve all or only partly the shoulder 6 and the corresponding inner end of the ring 5, so that the latter may be mounted on the portion 201 of the spindle 1 as though these two parts were two normal parts with a round cross-section and therefore without any need for relative angular alignment and, only after these two parts have been engaged together axially, is a relative rotation of the said parts performed in order to engage correctly the three-lobe profile of the ring 5 with the corresponding three-lobe profile of the shoulder 6 of the spindle and vice versa and, after this step involving correct angular alignment, the said axial locking edge 201′ will be formed by means of rolling.

Further characteristic features of the invention and the advantages arising therefrom will emerge more clearly from the following description of a preferred embodiment thereof illustrated purely by way of a non-limiting example in the figures of the two accompanying sheets of drawings in which, in addition to the already considered

FIG. 1 relating to the prior art:

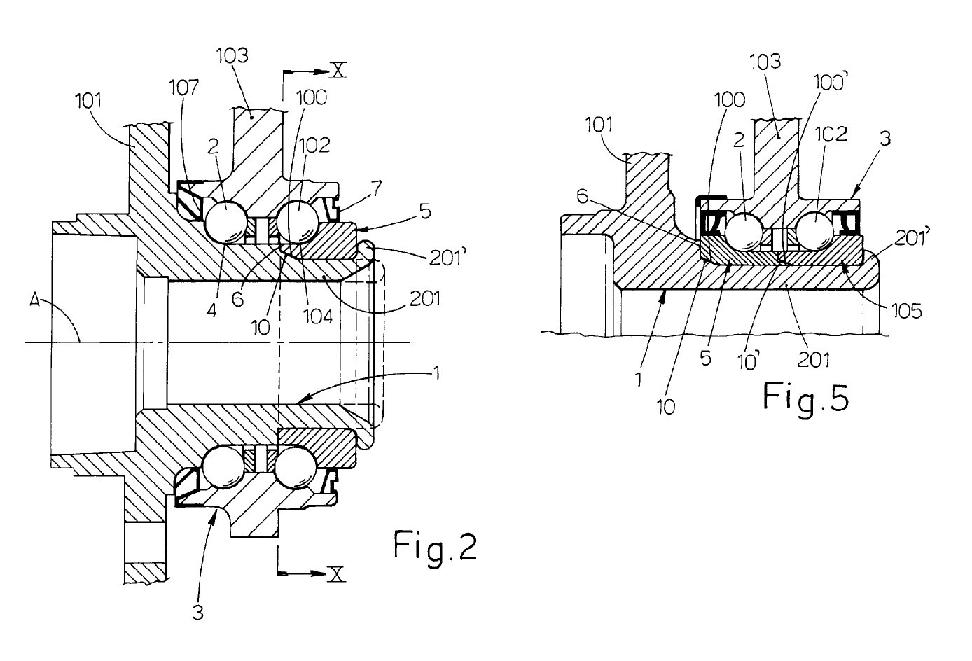

FIG. 2 shows a wheel hub of the same type as that shown in FIG. 1, but improved according to the invention;

FIGS. 3 and 4 show corresponding details of the three-lobe profile of the spindle and the ring, respectively, both viewed along the cross-sectional line X-X of FIG. 2;

FIG. 5 shows, axially cross-sectioned, another type of wheel hub with the inner rings of the bearings both mounted on the spindle and keyed with the latter using the same method according to the invention.

In the wheel hub shown in FIG. 2, components identical to those of the wheel hub shown in FIG. 1 are indicated by the same numbers, so that a description of these identical components is omitted.

According to the invention, when the spindle 1 is machined on the turning machine, the angle zone of its shoulder 6 is provided with a multiple-lobe machined zone, for example having a three-lobe profile as shown in FIG. 3, with lobes 10 raised outwards relative to the outer side surface of the externally cylindrical portion 201, with a round cross-section, of the spindle. These reliefs 10 may occupy, as mentioned, the angle zone of the shoulder 6 and/or may occupy the front surface of the latter only partly or over its entire extension.

Likewise, during machining of the ring 5 on the turning machine, its edge and/or its front face intended to co-operate with the said shoulder 6 of the spindle 1 is provided with three-lobe recesses 100, as can be seen from FIG. 4, complementing the aforementioned reliefs 10.

The result of the above is that the inner side surface of the ring 5 remains over its length, except for the small end part which may be occupied by the said three-lobe profile 100, perfectly cylindrical and with a round cross-section, similar to the entire length of the outer side surface of the portion 201 of the spindle, so that mounting of the ring 5 on this part 201 of the spindle is an extremely easy operation since the two parts must not be necessarily aligned with each other angularly before axial engagement. The recessed three-lobe profile 100 provided on the inner edge of the ring 5 forms, moreover, an effective guide means which facilitates correct axial engagement of the parts, even if these are not perfectly aligned axially.

Only subsequently, once the ring 5 has been mounted on the portion 201 of the spindle, will a small relative rotation of the two parts be performed and the latter pushed lightly against each other so as to cause the recessed three-lobe profile 100 of the ring 5 to engage with the raised three-lobe profile 10 of the shoulder 6 of the spindle, and this engaged condition may be easily detected with sensors since, when it occurs, the ring 5 touches the shoulder 6 and engages with the portion 201 of the spindle over the appropriate length, without performing any axial displacement on this portion 201.

When engagement of the aforementioned parts 201 and 5 has been performed, before subjecting them to the rolling procedure for formation of the locking edge 201′, the ring 5 may if necessary be locked in the correct angular position on the portion 201 of the spindle, with the prior or subsequent application of a few drops of adhesive, in any manner suitable for the purpose.

When the multiple-lobe parts 10 and 100 are engaged together, the same parts will form a small engaging joint partly of the radial type and partly of the frontal type or exclusively of the frontal type, this preventing relative rotation of the ring 5 and spindle 1 and the associated serious problems mentioned in the introductory part of the present description.

It is evident how the method described, in addition to simplifying the operation of keying the ring 5 onto the spindle 1, also simplifies the operation of forming the three-lobe profiles 10 and 100, since the same profiles are situated on a surface covering a small area, decidedly much smaller than that envisaged by the prior art according to the U.S. Pat. No. 7,241,054 mentioned in the introduction.

If the wheel hub is of the type shown in FIG. 5, with two rings 5 and 105 for the bearings 2 and 102, the inner ring 5 and the shoulder 6 are designed for keying together with a three-lobe engaged arrangement 10, 100, as described with reference to FIGS. 2, 3 and 4 and, moreover, three-lobe machined zones 10′ are provided on the rear edge of the ring 5 and other such zones 100′ are provided on the inner edge of the ring 105, in order to perform keying together of the two rings, such that the inner ring 5 is keyed directly onto the spindle 1 and the rear ring 105 is keyed onto the front ring 5 and, therefore, via the latter, also onto the spindle 1.

1. Method for producing vehicle wheel hubs provided with at least two crown parts of rolling means (2, 102), at least one of which (102) travels along an annular track (104) which is formed in a ring (5) which is mounted with a high degree of precision on an end portion (201) of the spindle (1) on which the same ring is axially locked by means of abutment, on one side, against a shoulder (6) and, on the other side, against a rolled end edge (201′) of the same spindle, characterized by the succession of following operating steps:
forming with the machine tools for turning the spindle (1), in the angle zone and/or only on the front surface of the said shoulder (6), a multiple-lobe profile, for example with a three-lobe form (10), which has parts raised relative to the outer side surface of the spindle portion (201) provided with the same shoulder (6) and on which the said ring (5) must be mounted;
forming with the machine tools for turning the said ring (5), on the edge and/or on the end of this ring which is intended to co-operate with the said shoulder (6), a machined zone for example with a three-lobe form (100) which complements and is able to mate with the machined zone (10) formed on the said shoulder (6) and which has parts which are recessed relative to the inner side surface of the ring (5) and which may act as guide means during the following step, i.e.:
axially mounting the ring (5) on the spindle portion (201) which it must support, operating in such a way that the said ring abuts against the said shoulder (6);
performing a brief relative rotation of the spindle (1) and the ring (5) so as to perform engagement between the said three-lobe profiles (10, 100) whereupon the ring engages with the spindle occupying the space of appropriate length and ceases to be axially displaced on the said spindle;
rolling the spindle portion (201) projecting from the said ring (5), for formation of a rolled edge (201′) which axially locks the said ring (5) on the support spindle (1).

2. Method according to claim 1, characterized in that it comprises, prior to the said last rolling step, a step where the ring (5) is locked in the correct axial and angular mounting position on the spindle portion (201), resulting in mutual co-operation of the said three-lobe profiles (10, 100), for example with the application of adhesive in any part of the contact surfaces of the ring (5) and the spindle (1).

3. Method according to claim 1, characterized in that, for the production of wheel hubs for vehicles, provided with at least two crown parts of rolling means (2, 102) which travel along tracks (4, 104) formed on respective rings (5, 105) mounted with a high degree of precision on an end portion (201) of the spindle on which the said rings are mounted in succession and are locked axially by means of abutment of the inner ring (5) against a shoulder (6) of the said spindle and by means of abutment of the outer ring (105) on one side against the said inner ring (5) and on the other side against a rolled end edge (201′) of the said spindle, the inner ring (5) and the shoulder (6) are designed so as to be keyed together with a said multiple-lobe—for example three-lobe (10, 100)—engaged arrangement, while further multiple-lobe machined zones, for example of the three-lobe type (10′), are provided on the rear edge of the said inner ring (5) and other multiple-lobe machined zones, for example of the three-lobe type (100′), are provided on the inner edge of the outer ring (105), in order to provide mutual keying between the two rings, so that the inner ring (5) is keyed directly onto the spindle (1) and the outer ring (105) is keyed onto the inner ring (5) and therefore, via the latter, also onto the spindle (1).

4. Vehicle wheel hub provided with at least two crown parts of rolling means (2, 102), at least one of which travels along an annular track (104) formed in a ring (5) which is mounted with a high degree of precision on an end portion (201) of the spindle (1) on which the same ring is axially locked by means of abutment against an inner shoulder (6) of the said spindle and by means of abutment against a rolled end edge (201′) of the said spindle, characterized in that the said shoulder (6) is machined on machine tools, so as to assume a multiple-lobe form, for example a three-lobe form (10), which has parts raised relative to the outer side surface of the spindle portion (201) on which the said ring (5) must be mounted and which mates perfectly with a corresponding three-lobe form (100) formed on the edge and/or on the end of the said ring (5) which is intended to rest against the said shoulder (6) so as to simplify the formation of the said three-lobe keying profiles and simplify mounting of the ring on the spindle, this three-lobe profiled form (100) being characterized in that it has parts which are recessed relative to the inner side surface of the said ring (5), so as to form a guide means which facilitates axial engagement of the said parts (5, 201).

5. Wheel hub according to claim 4, characterized in that if both the crown parts of rolling means (2, 102) travel along the respective tracks (4, 104) of respective rings (5, 105) mounted with a high degree of precision and in succession on an end portion (201) of the spindle on which the said rings are axially locked by means of abutment of the inner ring (5) against a shoulder (6) of the same spindle and by means of abutment of the outer ring (105) on one side against the said inner ring (5) and on the other side against a rolled end edge (201′) of the same spindle, the inner ring (5) and the shoulder (6) are designed to be keyed together with a said three-lobe engaged arrangement (10, 100), while further three-lobe machined zones (10′) are provided on the rear edge of the said inner ring (5) and other three-lobe machined zones (100′) are provided on the inner edge of the outer ring (105), in order to provide mutual keying between the two rings, so that the inner ring (5) is keyed directly onto the spindle (1) and the outer ring (105) is keyed onto the inner ring (5) and therefore, via the latter, also onto the spindle (1).
